(19) United States
(12) Patent Application Publication
(10) Pub. No.: US 2024/0391320 A1
(43) Pub. Date: Nov. 28, 2024

(54) CONTROL SYSTEM FOR A VEHICLE DISPLAY SYSTEM

(71) Applicant: JAGUAR LAND ROVER LIMITED, Whitley, Coventry, Warwickshire (GB)

(72) Inventor: Riccardo FRACCHIA, Coventry, Warwickshire (GB)

(21) Appl. No.: 18/700,695

(22) PCT Filed: Oct. 19, 2022
(86) PCT No.: PCT/EP2022/079118

§ 371 Date: Apr. 11, 2024

(30) Foreign Application Priority Data
Oct. 22, 2021 (GB) 2115250.9

(51) Int. Cl. B60K 35/28; B60K 35/22; B60K 35/29; B60W 30/14; B60W 30/184; B60W 30/188; B60W 50/14

(52) U.S. Cl. CPC B60K 35/28; B60K 35/22; B60K 35/29; B60W 30/146; B60W 30/184; B60W 30/188; B60W 50/14; B60K 2360/167; B60K 2360/168; B60K 2360/178; B60K 2360/1876; B60W 2050/146; B60W 2400/00

(57) ABSTRACT

The present invention relates to a control system (200) for a vehicle display system. The vehicle display system (300) is configured to display information relating to the operation of a powertrain (102) of the vehicle (100, 700). The control system (200) comprises an input (204) configured to receive restriction data (502) relating to a speed restriction of the vehicle (100, 700) and speed data (504) comprising a speed the vehicle (100, 700) is travelling; a processor (202) configured to determine from the restriction data (502) and the speed data (504) whether a predetermined criterion is met; and an output (206) configured to output a signal to display an indication that the vehicle (100, 700) is subject to a speed restriction when the predetermined criterion is met. Aspects of the present invention relate to a control system, to a vehicle display system, to a computer readable data carrier and to a vehicle.

### TECHNICAL FIELD

The present disclosure relates to a control system for a vehicle display system. Aspects of the invention relate to a control system, to a vehicle display system, to a computer readable data carrier and to a vehicle.

### BACKGROUND

On electrified vehicles, especially battery electric vehicles, it can be useful to display to the driver an indication of the efficiency of the functioning of the powertrain. For example, it may be useful to show how much of the full powertrain capability is being used to accelerate or decelerate the vehicle. In this situation, it can be useful to display to the driver an indication of the instantaneous power delivery of the powertrain expressed as a proportion of the instantaneous capability of the powertrain.

There arises a problem when either an everyday temporary condition or a fault condition causes the availability of power and/or torque of the powertrain to reduce significantly. This variation in the powertrain capability may be a function of the state of the components (such as component temperature, machine rotational speeds and battery state). In some cases, the vehicle may be subject to temporary speed restrictions due to these changes in the outputs of its components. In general, the limitation of powertrain capability would not be apparent to the driver until the vehicle speed reaches the speed restriction and the vehicle will not further accelerate.

It is an aim of the present invention to address one or more of the disadvantages associated with the prior art.

### SUMMARY OF THE INVENTION

Aspects and embodiments of the invention provide a control system for a vehicle display system for a vehicle, a vehicle display system for a vehicle, a method of rendering on a vehicle display system information relating to the operation of a powertrain of the vehicle, a computer readable data carrier, and a vehicle as claimed in the appended claims.

According to an aspect of the present invention there is provided a control system for a vehicle display system for a vehicle, the control system comprising one or more controller, wherein the vehicle display system configured to display information relating to the operation of a powertrain of the vehicle and the control system is arranged to: receive restriction data relating to a speed restriction of the vehicle and speed data comprising a speed the vehicle is travelling; determine from the restriction data and the speed data whether a predetermined criterion is met; output a signal to the vehicle display system to display an indication that the vehicle is subject to a speed restriction when the predetermined criterion is met.

The restriction data may be received by an input of the control system. The determination of whether a predetermined criterion is met may be performed by a processor. The signal may be outputted by an output. Each of the input, processor and output may be provided by a single controller. In the alternative, two or more of the input, processor and output may be provided by two or more controllers. In this way, the control system provides for warning a driver of a limitation in vehicle capability, but only when the vehicle state indicates that the speed restriction may be reached. The control system provides for displaying an indication of the speed restriction only when it is relevant to the driver. The indication of the speed restriction will not be displayed if the current vehicle speed is likely to be unaffected by the speed restriction. However, it is useful to provide an indication for the driver to be aware that further acceleration may be restricted.

In an embodiment, the restriction data includes a restriction speed to which the vehicle is restricted. In this way the speed to which the vehicle may be restricted can be considered when determining how and when to display the indication.

Optionally, the processor being configured to determine whether a predetermined criterion is met comprises the processor being configured to calculate a value for a first function of the restriction speed and the speed the vehicle is travelling, and to assess that value in relation to a threshold value. The value may be assessed by comparing it to the threshold value. The value of the first function may be derived from a look-up table based on the speed the vehicle is travelling and the restriction speed. The value may be determined using linear interpolation. The threshold value may be determined in relation to the look-up table. The threshold value may be a function of the restriction speed. In this way, the control system can control the display of the indication to ensure it is displayed when the information is relevant to the driver.

The predetermined criterion may comprise the speed data indicating that the speed the vehicle is travelling is within a threshold value of the speed restriction speed. The threshold value may be a function of the restriction speed. The threshold value may be a function of the restriction speed and the vehicle speed. Having an indicator that varies with variations in the vehicle speed illustrates that a restriction in the vehicle speed is in force. The predetermined criterion being met may comprise the speed data indicating that the speed the vehicle is travelling is above a threshold. The predetermined criterion being met may comprise the speed data indicating that the speed the vehicle is travelling is below a threshold. For example, an example threshold may be speed limit for the road on which the vehicle is travelling.

In an embodiment the indication comprises an indication value, wherein the indication value is a value for a second function of the restriction speed and the speed the vehicle is travelling. The indication value may be represented as a percentage or other proportional or fractional value. Where the indication value is represented as percentage, the threshold value may be 100 corresponding to 100%, with similarly derived threshold values for other proportional or fractional values that may be used for the indication value. The value of the second function may be derived from a look-up table based on the speed the vehicle is travelling and the restriction speed. The look-up table for the second function may be related to the look-up table associated with the first function. The indication value may be determined using linear interpolation. In this way, the control system can inform the driver of reduced capability using an indication that becomes more severe as the vehicle speed becomes closer to the restriction speed, therefore the driver can anticipate that the vehicle will reach a speed from which it will accelerate no further.

Optionally, the first function and second function are the identical such that the indication value is assessed in relation to the threshold value to determine if the predetermined condition is met. This is a convenient way of assessing if an indication should be displayed and the severity of the indication. Optionally, the second function may be configured such that the indication value corresponds to a value representative of a power suitable for maintaining the restriction speed. Optionally, the second function may be configured such that the indication value corresponds to a value representative of a power suitable for maintaining the restriction speed as a proportion of a power capability of the powertrain. In this way, the indication value may be conveniently integrated into the information relating to the operation of a powertrain. For example, when the vehicle is travelling at the restriction speed, the indication value can also provide information to the user in relation to likely power consumption of the vehicle at that speed.

The look-up table may comprise values representative of a power suitable for maintaining the vehicle at a steady speed. The look-up table may comprise values representative of a power suitable for maintaining the vehicle at a steady speed as a proportion of a power capability of the powertrain. This is an efficient way of providing a link between the indication value, and the power output of the powertrain.

According to another aspect of the invention, there is provided a vehicle display system for a vehicle, the vehicle display system configured to display information relating to the operation of the powertrain of the vehicle and comprising a control system as described herein.

In an embodiment the vehicle display system comprises a display to graphically render information relating to the operation of the powertrain of the vehicle and where in the output is configured to include a gauge marker to the display as the indication. Optionally, the display comprises a gauge having a lower limit representing zero or negligible power delivery of the powertrain and an upper limit representing maximum power delivery equal to the instantaneous power capability and the gauge marker is positionable between the lower limit and upper limit. The gauge marker may be positionable at a position corresponding to an indication value that is a value for a second function of the speed the vehicle is travelling and the restriction speed. The gauge may be in the form of a scale. The scale may for example representatively display a ratio representing the instantaneous power delivery of the powertrain as a proportion of the instantaneous power capability. Optionally, the gauge marker of the vehicle display system may be positionable on the gauge at a position corresponding to the indication value. In this way, the gauge marker can be used to indicate the proximity of the vehicle's speed to the restriction speed.

The vehicle display system may comprise a power indicator adapted to represent the instantaneous power delivery of the powertrain as a proportion of the instantaneous power capability wherein the power indicator is positionable between the lower limit of the gauge and the gauge marker. In this way, the position of the power indicator is capped by the position of the gauge marker. The power indicator and the gauge marker may converge. The position of the gauge marker may be based on the indication value which may be configured, via the values of the look-up table, to correspond to a position of the gauge corresponding to a power for maintaining the vehicle at the speed restriction speed. Thus, as the vehicle approaches the restriction speed, the vehicle may be able to deliver a greater amount of power than is represented by the indication value. However, it may be potentially confusing to the user to display a greater available power as this may not convey that the acceleration may be limited. Therefore, by limiting the upper limit of the power indicator to the position of the gauge marker, any risk of providing the user with potentially confusing information is reduced.

According to yet another aspect of the invention, there is provided a method of rendering, on a vehicle display system, information relating to the operation of a powertrain of the vehicle, the method comprising: determining from restriction data, relating to a speed restriction of the vehicle and speed data comprising a speed the vehicle is travelling whether a predetermined criterion is met; and displaying an indication that the vehicle is subject to a speed restriction when the predetermined criterion is met. In this way, the method provides for altering the driver to speed restriction only when it is likely that the speed restriction will affect the speed of the vehicle.

In an embodiment, the restriction data includes a restriction speed to which the vehicle is restricted. In this way the speed to which the vehicle may be restricted can be considered when determining how and when to display the indication.

Optionally, determining whether the predetermined criterion is met comprises calculating a value for a first function of the restriction speed and the speed the vehicle is travelling, and assessing that value in relation to a threshold value. The value of the first function may be derived from a look-up table based on the restriction speed and the sped the vehicle is travelling. The threshold value may be derived from the look-up table. The threshold value may be a function of the restriction speed. In this way, the indication may be displayed when it is relevant to the driver.

In an embodiment, displaying the indication comprises displaying the indication at a position determined by an indication value wherein the indication value is a value for a second function of the restriction speed and the speed the vehicle is travelling. The first function and second function may be identical such that determining if the predetermined condition is met comprises assessing the indication value in relation to the threshold value. In this way, evaluating a single function can determine if an indication is to be displayed and how it is to be displayed.

The second function may be configured such that the indication value corresponds to a value representative of a power suitable for maintaining the restriction speed. The second function may be configured such that the indication value corresponds to a value representative of a power suitable for maintaining the restriction speed as a proportion of a power capability of the powertrain. In this way, the indication value may be conveniently integrated into the information relating to the operation of a powertrain.

The method may comprise deriving a value for one or both of the first function and the second function from a look-up table based on the speed the vehicle is travelling and the restriction speed. The look-up table may comprise values representative of a power suitable for maintaining the vehicle at a steady speed. The look-up table may comprise values representative of a power suitable for maintaining the vehicle at a steady speed as a proportion of a power capability of the powertrain.

Optionally, the look-up table comprises values representative of a power suitable for maintaining the vehicle at a steady speed. The look-up table may comprise values representative of a power suitable for maintaining the vehicle at a steady speed as a proportion of a power capability of the powertrain. In this way, the look-up table values can be chosen such that the value for the first function and/or second function provide information on the likely power requirements for the steady speed. The look-up table values may be stored in memory, and/or may be updated. They may be updated based on data included in the restriction data relating to the power usage of the vehicle.

According to a further aspect of the invention, there is provided a computer readable data carrier. The computer readable data carrier may have stored thereon a computer program comprising instructions which, when the program is executed by a computer, cause the computer to carry out a method described herein.

According to a still further aspect of the invention, there is provided a vehicle. The vehicle may comprise a control system as described herein. The vehicle may comprise a vehicle display system as described herein. The vehicle may operate such that a power suitable for maintaining the restriction speed is less than the instantaneous power capability of the powertrain. The vehicle may be a battery electric vehicle or a hybrid electric vehicle, and the powertrain may comprise a battery pack and one or more electric motors. The vehicle may be a fuel cell powered electric vehicle.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic representation of a powertrain of a battery electric vehicle;

FIG. 2 shows a first block diagram illustrating a control system according to an embodiment of the invention;

FIG. 3 shows a second block diagram illustrating a vehicle display system according to an embodiment of the invention;

FIGS. 4(a), (b) and (c) show example displays of the vehicle display system according to an embodiment of the invention;

FIGS. 5(a), (b), and (c) show example displays for displaying information relating to the operation of the powertrain of the vehicle according to the prior art;

FIGS. 6(a), (b), and (c) show example displays for displaying information relating to the operation of the powertrain of the vehicle according to an embodiment of the invention;

FIG. 7 shows a flow chart illustrating a method according to an embodiment of the invention;

FIG. 8 shows a graph illustrating the operation of an embodiment of the invention; and

FIG. 9 shows a vehicle in accordance with an embodiment of the invention.

### DETAILED DESCRIPTION

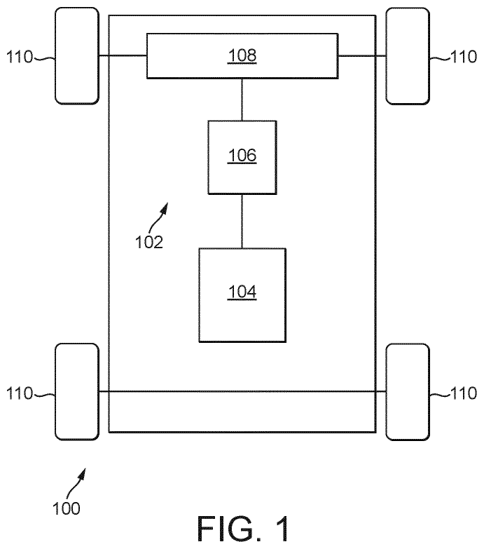

FIG. 1 shows a vehicle, indicated generally by the reference numeral 100, suitable for use with embodiments of the invention. The vehicle 100 comprises a powertrain, indicated generally by the reference numeral 102. The powertrain 102 includes a power source 104 for providing electrical energy, a prime-mover 106 in the form of an electric motor for converting the electrical energy into kinetic energy, and a transmission 108 for delivering the kinetic energy from the prime-mover 106 to the wheels 110. The transmission 108 may include a clutch, gearbox, differential and fixed gearing as known in the art and will not be discussed in detail here. The vehicle 100 may be a battery electric vehicle, fuel cell electric vehicle, hybrid electric vehicle, or other electric vehicle type. In a battery electric vehicle, the power source 104 comprises a battery pack for storing and discharging electrical energy. In a fuel cell electric vehicle, the power source 104 comprises a fuel cell system.

While one motor is shown, it will be understood that the vehicle 100 may comprise one or more electric motors. Similarly, while one transmission is shown, it will be understood that the vehicle may comprise one or more transmissions. In an example, the vehicle 100 may comprise an individual motor and transmission set per wheel.

In certain situations, such as in regenerative braking for example, kinetic energy may be converted back to electric energy by the motor 106 (acting in reverse as a generator) and stored in the power source 104 for later use. As such, the power delivery from the powertrain 102 may be positive, for example when power is being delivered from the power source 104 to the wheels 110 to accelerate the vehicle 100, or negative, for example when power is being delivered to the power source 104 from the wheels 110 as the vehicle 100 decelerates.

The power source 104 may include one or more batteries (not shown) and associated controllers (not shown). The battery controllers may be used to monitor, inter alia, operating temperature, battery charge level and instantaneous discharge capability of the battery.

The motor 106 may include power electronics (not shown) and one or more controllers (not shown). The motor 106 may be controlled by a powertrain controller (not shown) comprising one or more processors configured to receive instructions from the driver of the vehicle via an electronics control unit or ECU (not shown) as is known in the art.

The maximum amount of power available from the powertrain 102, referred to herein as the powertrain capability, may vary according to a number of factors. Such factors may include power source temperature, motor temperature, motor speed and state of charge of the battery pack in a battery elective vehicle. As such the powertrain capability varies dynamically. Powertrain capability can affect the speeds at which the vehicle may travel.

It may be desirable to display to the driver an indication of the instantaneous power delivery from the powertrain 102 as a proportion of the instantaneous powertrain capability. Such information may help inform the driver of their driving style and/or improve driving efficiency, for example.

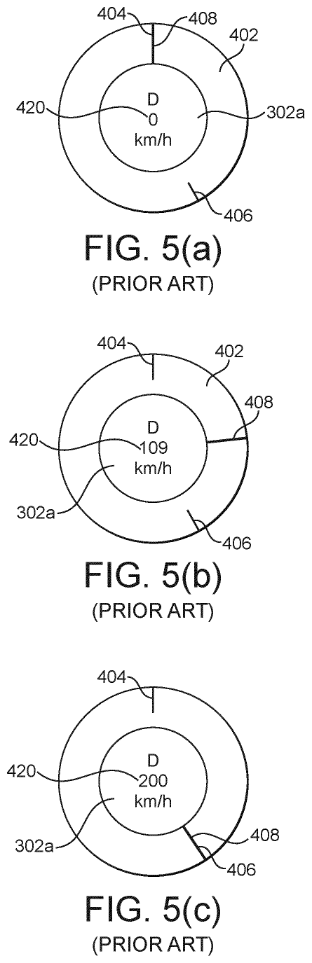

In an example, a system to display an indication of the instantaneous power delivery comprises a display 302a including a gauge 402, visible to the driver of the vehicle 100. A lower limit 404 of the gauge 402 represents zero or negligible power delivery of the powertrain 102 and an upper limit 406 of the gauge 402 represents the maximum power delivery which is substantially equal to the power capability of the powertrain 102. A power indicator 408 positioned between the lower limit 404 and upper limit 406 may represent the instantaneous power delivery as a proportion of the instantaneous power capability. Such a known display 302a is described herein in relation to FIGS. 5(a)-(c). The display 302a illustrated in FIGS. 5(a)-(c) may optionally also displays other information for the driver. For example a numerical speed indicator 420 and/or other information such as the gear the vehicle is in, the battery charge state, odometer etc. which may or not be on other embodiments of the display 302a.

Some situations can lead to the imposition of a vehicle speed restriction. Such a vehicle speed restriction may specifically restrict the speed at which the vehicle can travel to a certain speed. Such a speed restriction may be useful in preserving component longevity; avoiding or reducing component damage; avoiding component de-rate; or the like.

Component de-rate may be understood to refer to a situation where a component deviates from its defined operating output, and may result in the component providing a reduced output. Such a reduced output may be as a result of operating conditions such as power output and temperature and/or the state of the system. Restrictions on the vehicle's speed may be understood to be generally a preventative measure. A speed restriction allows for a controlled gradual reduction in performance to protect against a possible abrupt, and potentially intrusive and disruptive to the driver, reduction in performance.

The present invention is directed towards a control system 200 comprising one or more controller. The control system is for a vehicle display system 300 for a vehicle 100, where the vehicle display system 300 is configured to display information relating to the operation of a powertrain 102 of the vehicle 100. The vehicle display system 300 is also configured to display an indication that the vehicle 100 is subject to a speed restriction when a predetermined criterion is met. A speed restriction may be understood to refer to an applied restriction to the speed such that the maximum allowed speed is lower than the normal maximum possible speed of the vehicle 100. A speed restriction may be further understood to refer to a restriction applied specifically to the speed at which the vehicle may travel, which is not an indirect restriction on the speed via a restriction on the available power, torque, or the like. The invention thus aims to deliver information to the driver only when it is considered relevant to the driving experience so as to prevent unnecessary distraction of the driver.

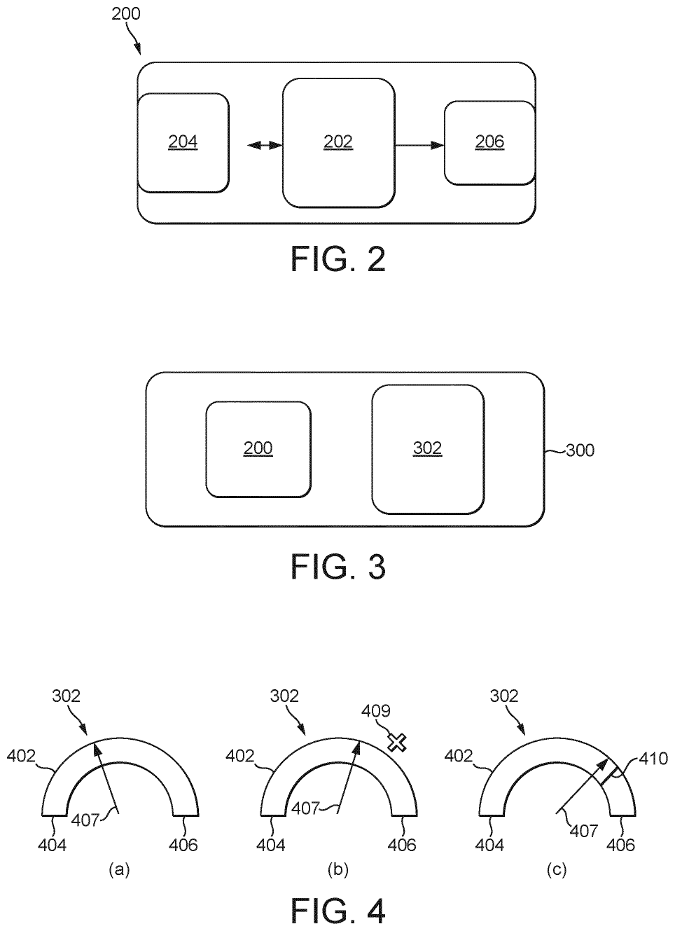

Referring now to FIG. 2, there is shown a block diagram illustrating a control system according to an embodiment of the invention. The control system is suitable for use in or with a vehicle display system which is configured to display information relating to the operation of the powertrain of the vehicle in question. The control system, indicated generally by the reference numeral 200, comprises a processor 202, an input 204, and an output 206. It will be appreciated that each of the processor, input and output may be provided by separate controllers or may be provided by a single controller unit. The embodiment shown in FIG. 2 comprises a single controller. The input 204 is configured to receive restriction data relating to a speed restriction of the vehicle 100 and speed data relating to a speed the vehicle 100 is travelling. The processor 202 is configured to determine from the restriction data and the speed data whether a predetermined criterion is met. The output 206 is configured to output a signal to display an indication that the vehicle 100 is subject to a speed restriction when the predetermined criterion is met. The restriction data may include a restriction speed to which the vehicle 100 is restricted. The speed data may comprise the speed the vehicle is travelling.

In an example, the processor 202 of the control system 200 calculates as it has been configured to do so a value for a first function of the restriction speed and the speed the vehicle 100 is travelling, and assesses that value in relation to a threshold value. In an example, the first function may be the difference between the restriction speed and the speed the vehicle 100 is travelling, which difference is then compared with a threshold value. As such, the control system may be adapted to initially determine if a speed restriction has been applied, then determine how close the vehicle speed is to the restriction speed. If the vehicle speed is sufficiently close to the restriction speed, the indication is displayed. The threshold value may be a function of the restriction speed, for example a percentage or the like. In another example, a value for the first function may be obtained via a look-up table, and then compared with a suitable threshold value.

As discussed above, the restriction data may comprise data relating to a speed restriction. The restriction data may comprise data relating to a condition indicative of the speed restriction of the vehicle. Such conditions may include conditions that impose a maximum value on the speed at which the vehicle may travel. Such conditions may include information that thermal management of a traction component is indicated, or that actions to protect and/or preserve components are indicated. The restriction data may further comprise data relating to a power delivery suitable for allowing the vehicle to travel at the restriction speed.

As discussed above, applying a speed restriction may be understood to be a pre-emptive or preventative measure, to facilitate a managed gradual reduction in performance to protect against a potential sudden reduction in performance.

For example, a speed restriction may be applied as a result of thermal management or component protection measures for a traction component such as a battery or fuel cell, energy converter, motor inverter, motor, or the like. Component protection measures may come into effect if an issue or fault is detected with a component. For example, if a fault is detected in a clutch or transmission that would be exacerbated by a higher vehicle speed, then the vehicle may be restricted to a speed below which the clutch or transmission can operate without further issue. Other reasons for a speed restriction could include that the electrical energy reserve level in a fuel cell electric vehicle is low, or that the instantaneous power capability of the fuel cell is low, or (in any type of electric vehicle or fuel cell electric vehicle) that the bulk energy level from the combined energy sources is low.

As another example, a period of sustained high-speed driving resulting in prolonged high traction demand could cause a high voltage (HV) battery average cell temperature to rise. The thermal management strategy for the HV battery specifies a reduction in battery discharge rate by means of a restriction on the vehicle speed. In this way, the battery temperature does not continue to rise. If the battery temperature were to continue to rise, battery performance and lifetime could be affected, and a sudden reduction in the allowed battery discharge rate would have to be made. Such sudden reductions are undesirable during vehicle operation. In a further example, a speed restriction may be applied as a result of a user setting. For example, in a fuel cell vehicle, if a user has selected the “economical” driving mode, this may result in a speed restriction being applied.

The restriction speed may be determined by whatever process is causing the speed restriction. In examples, the restriction speed may be upwards of 100 km/h, however it will be understood that the invention is not limited to any particular restriction speed, and will operate at any restriction speed specified by the vehicle systems and/or processes. In some examples the restriction speed is defined as a steady speed, however another examples the restriction speed ramps downward at a controlled rate until it reaches a desired steady speed, so as to avoid a sudden significant reduction in vehicle speed.

As discussed above, the speed data relates to the speed at which the vehicle is travelling. The speed data may comprise the speed at which the vehicle is travelling. The speed data may further comprise other speed-related data, for example an estimation of the road load of the vehicle. Estimation of the road load may include considering the vehicle weight; the gradient of the road; whether the vehicle is towing a trailer, and so on.

The predetermined condition may define that a value for a first function of the restriction speed and the speed the vehicle 100 is travelling is above a threshold value. For example, the predetermined condition may define that the speed the vehicle is travelling is within a threshold value of the restriction speed. The threshold value may be dependent on the restriction speed, for example a percentage thereof. The threshold value may also be dependent on the characteristics of the vehicle such as power, rates of acceleration, and speed. In an example, the threshold value is derived from a look-up table. The look-up table may be calibrated based on a power graph for the vehicle type and user-behaviour information. While examples of the predetermined condition are described above, the predetermined condition is not limited to those examples. For example, the predetermined criterion may comprise that the speed data indicates that the speed the vehicle is travelling is above a threshold, or the predetermined criterion may comprise the speed data indicating that the speed the vehicle is travelling is below a threshold. An example threshold may be speed limit for the road on which the vehicle is travelling.

The indication may comprise an indication value that is a value for a second function of the speed the vehicle 100 is travelling and the restriction speed. The indication value may illustrate how close the vehicle speed is to the restriction speed. In this way the indication may be displayed to the vehicle driver at a position indicating how close the vehicle 100 is to reaching the restriction speed. When the vehicle 100 is travelling at the restriction speed, the indication value may settle at the restriction speed. The first function may be identical to the second function. In this way, the indication value is assessed in relation to a threshold value to determine if the predetermined condition is met. A value for one or both of the first function and the second function may be derived from a look-up table based on the speed the vehicle is travelling and the restriction speed. In an example, the second function is configured such that the indication value corresponds to a value representative of a power suitable for maintaining the restriction speed, in particular the indication value may correspond to a value representative of a power suitable for maintaining the restriction speed as a proportion of a power capability of the powertrain. The look-up table may be configured to facilitate this representation of the indication value. For example, the look-up table may comprise values representative of a power suitable for maintaining the vehicle at a steady speed, in particular values representative of a power suitable for maintaining the vehicle at a steady speed as a proportion of a power capability of the powertrain.

Referring now to FIG. 3, there is shown a block diagram illustrating a vehicle display system 300 according to an embodiment of the invention. The vehicle display system 300 is configured to display information relating to the operation of the powertrain 102 of the vehicle 100. The vehicle display system 300 comprises a display 302 and control system 200 as described herein. The display 302 may graphically render information relating to the operation of the powertrain 102 of the vehicle 100 and include an output from the control system wherein the output is configured to include signal for a gauge marker on the display 302 as the indication.

The display 302 may comprise a gauge (not shown) on which the indication may be displayed. The indication may be a gauge marker that is static, or may be a gauge marker that moves along the gauge according to the relationship between the vehicle speed and the restriction speed. The gauge marker may move towards the lower end of the gauge either when the vehicle speed approaches the restriction speed, when the speed restriction approaches the vehicle speed, or a combination of both.

The display 302 may further comprise a power indicator (not shown). The power indicator may be adapted to represent the instantaneous power delivery of the powertrain, in particular as a proportion of the instantaneous power capability. The power indicator may be positionable between the lower end of the gauge and the upper end thereof.

The control system 200 may be part of the vehicle display system 300, or may be separate therefrom and provide control signals thereto.

Referring now to FIGS. 4(a), (b), (c), there is shown an example display 302 of the vehicle display system 300 according to an embodiment of the invention. The display 302 provides information relating to the operation of the powertrain 102 of the vehicle. The display 302 comprises a gauge 402 having a lower limit 404 and an upper limit 406. The lower limit 404 may represent zero or negligible power delivery of the powertrain 102. The upper limit 406 may represent maximum power delivery. Maximum power delivery may be understood to be substantially equal to the instantaneous power capability of the powertrain. It will be understood that this is an example display and that other forms of display to provide information relating to the operation of the powertrain may be used. The display 302 further comprises an indicator needle 407. The indicator needle 407 has a fixed end and a free end. The indicator needle 407 pivots such that the free end is positionable between the lower limit 404 and upper limit 406. The position of the indicator needle 407 may represent the speed of the vehicle, or other information relating to the operation of the powertrain. The position of the indicator needle 407 may correspond to a power indicator where it represents the instantaneous power delivery of the powertrain as a proportion of the instantaneous power capability.

In FIG. 4(a), no indication that the vehicle is subject to a speed restriction is displayed. As such, either there is no speed restriction in force on the vehicle, or there is a speed restriction but the predetermined criterion has not been met.

In FIG. 4(b), an indication that the vehicle is subject to a speed restriction is displayed. The indication is displayed in the form of a static symbol which is a gauge marker 409 adjacent to the gauge 402. In FIG. 4(b), the indicator needle 407 is positioned closer to the upper limit 406 than in FIG. 4(a), indicating, for example, the vehicle is travelling at a faster speed or has a higher ratio of instantaneous power delivery to instantaneous power capability than in FIG. 4(a). The gauge marker 409 indicates that a speed restriction is in operation on the vehicle.

In FIG. 4(c), an indication that the vehicle is subject to a speed restriction is displayed. The indication is displayed in the form of a gauge marker 410 on the gauge 402. The gauge marker 410 is positionable between the lower limit 404 and the upper limit 406. The gauge marker 410 may be displayed at a position on the gauge 402 that corresponds to an indication value. The indication value may be a function of the speed the vehicle is travelling and the restriction speed. In FIG. 4(c), the indicator needle 407 is positioned closer to the upper limit 406 than in FIG. 4(b) indicating, for example, that the vehicle is travelling at a faster speed or has higher ratio of instantaneous power delivery to instantaneous power capability than in FIG. 4(b). The indication value may be displayed as the static symbol gauge marker 409, as the positionable gauge marker 410, as a combination of both, or in another way.

Referring now to FIGS. 5(a), (b), (c), there is shown prior art examples of a display 302a configured to display information relating to the operation of a powertrain 102, under different operating conditions of a vehicle, such as the vehicle 100. The display 302a comprises a circular display having a gauge 402 on the right hand side thereof. The gauge 402 has a lower limit 404 representing zero or negligible power delivery of the powertrain 102 and an upper limit 406 representing maximum power delivery, which is substantially equal to the power capability of the powertrain 102. The display 302a further comprises a power indicator 408 that represents the instantaneous power delivery as a proportion of the instantaneous power capability, such that the power indicator 408 is positionable between the lower limit 404 and upper limit 406. FIGS. 5(a), (b) and (c) indicate prior art operation of the vehicle display system, where the power indicator 408 is displayed at a position along the gauge 402, where its position corresponds to the power the vehicle is using relative to the maximum power delivery at that instant. In FIG. 5(a), the vehicle is stationary and the power indicator 408 is positioned at the lower limit 404. In FIG. 5(b), the vehicle is driving at a speed of 109 km/h, and the power indicator 408 is positioned slightly further that half-way along the gauge 402. In FIG. 5(c), the vehicle is driving at a speed of 200 km/h, and is using the maximum available power. The power indicator 408 is located at the position of the upper limit 406 for power delivery. In each of FIGS. 5(a), (b) and (c), the speed the vehicle is travelling is shown in the centre of the display with a numerical speed indicator 420. While there is some correlation between the speed the vehicle is travelling and the position of the power indicator 408, the rate of acceleration of the vehicle will also affect the power requirement and so the position of the power indicator 408.

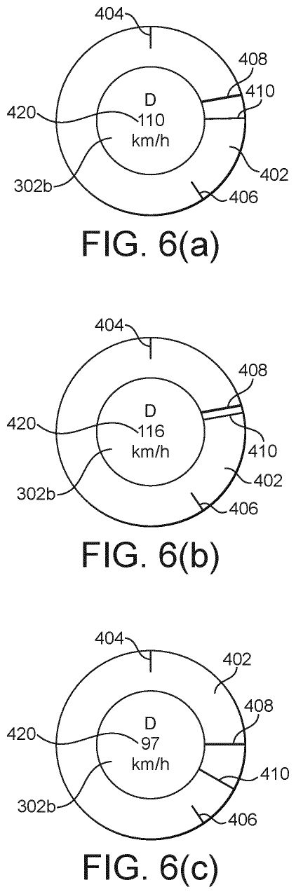

Referring now to FIGS. 6(a), (b), (c), there is shown examples of a display 302b of a vehicle display system 300 according to an embodiment of the invention. The display 302b of FIG. 6 provides examples of the indication of a speed restriction in a display similar to the display 302a of FIG. 5. As such, FIGS. 6(a), (b), (c), show the gauge 402 having a lower limit 404, upper limit 406 and power indicator 408 as shown in FIGS. 5(a), (b), (c). When the processor 202 determines from the speed data and the restriction data that the predetermined condition is met, the control system 200 causes an indication in the form of a gauge marker 410 to be displayed on the gauge 402. In the example illustrated in FIG. 6, the predetermined condition comprises the value of a first function of the restriction speed and the speed the vehicle is travelling being less than a threshold value. The gauge marker 410 is displayed at a position between the lower 404 and upper 406 limits, wherein the position is determined by an indication value that is derived from a second function of the speed the vehicle is travelling and the restriction speed. In the present example, the first function is identical to the second function. In this way, the indication value is assessed in relation to a threshold value to determine if the predetermined condition is met. If the indication value is less than a threshold value, the indication is displayed on the display, in the form of the gauge marker 410.

In FIG. 6(a), the vehicle is subject to a speed restriction. The restriction speed is 120 km/h (not shown). The vehicle is travelling at 110 km/h and may be accelerating. The power indicator 408, representing the instantaneous power delivery as a proportion of the instantaneous power capability, is displayed at the relevant position on the gauge 402. As discussed above, the processor 202 has determined that the predetermined condition has been met and has thus determined that the gauge marker 410 should be displayed. The indication value is such that the gauge marker 410 is displayed at approximately a 3 o'clock position on the circular display. In FIG. 6(b), the vehicle speed is at a steady speed of 116 km/h, and is thus closer to the restriction speed. To indicate this, the indication value is lower such that the gauge marker 410 has moved closer to lower limit 402. The gauge marker 410 is now very close to the power indicator 408 indicating that the vehicle's speed is very close to the restriction speed. In this example, this also indicates that the power usage is very close to the available power. The power indicator 408 has also moved closer to the lower limit of the gauge, since the vehicle is no longer accelerating. In this way, when the predetermined condition has been met, the gauge marker 410 appears on the gauge 402 and gets closer to the lower limit 404 as the vehicle speed gets closer to the restriction speed.

The gauge marker 410 also gets closer to the power indicator 408 as the vehicle speed gets closer to the restriction speed. This may be implemented through the manner of calculation of the indication value, for example through appropriate selection of values in a look-up table.

In an example, the position of the power indicator 408 is capped at the position of the gauge marker 410. In this way, the power indicator 408 cannot move above the position of the gauge marker 410 on the gauge 402. If the delivered power is greater than that represented by the gauge marker 410 and the vehicle speed is below the restriction speed, then the power indicator 408 is simply capped to the value of the gauge marker 410 and the power indicator 408 displays a lower amount of power than is being delivered until the vehicle speed meets the restriction speed. If there is no gauge marker 410 displayed on the gauge 402, the power indicator 408 can move between the lower limit 404 and upper limit 406 as appropriate.

FIG. 6(c) provides a further example of the display 302b including the indication of the speed restriction provided by the control system 200 according to the present disclosure. The gauge marker 410 is in place on the gauge 402 and the power indicator 408 is also displayed. In FIG. 6(c), the power indicator 408 is located at approximately 3 o'clock on the circular display, and the gauge marker 410 is located at approximately a 4 o'clock position.

The displays 302a, 302b illustrated in FIGS. 5 and 6(a)-(c) may optionally display other information for the driver and or a passage of the vehicle. For example a numerical speed indicator 420 and/or other information such as the gear the vehicle is in, the battery charge state, odometer, and other information that the driver and or passenger may find useful.

In an example, the indication value is calculated by bilinear interpolation of a lookup table using the instantaneous vehicle speed and restriction speed as inputs. The lookup table is calibrated according to the characteristics of each vehicle make and model. The look-up table values may be chosen such that the indication value is representative of a percentage, in which case the threshold value may be 100. Similarly, the indication value may be representative of a fraction, such that the threshold value would be 1. Other suitable representative methods will be apparent to the person skilled in the art.

In an example, the first function used in determining if the predetermined condition is met, and the second function for determining the indication value are identical. The indication value, which controls the position of the gauge marker 410, is derived according to the following formula:

$$P \approx \frac{( {x}_{2} - x ) ( {y}_{2} - y )}{( {x}_{2} - {x}_{1} ) ( {y}_{2} - {y}_{1} )} {Q}_{11} + \frac{( x - {x}_{1} ) ( {y}_{2} - y )}{( {x}_{2} - {x}_{1} ) ( {y}_{2} - {y}_{1} )} {Q}_{21} + \frac{( {x}_{2} - x ) ( y - {y}_{1} )}{( {x}_{2} - {x}_{1} ) ( {y}_{2} - {y}_{1} )} {Q}_{12} + \frac{( x - {x}_{1} ) ( y - {y}_{1} )}{( {x}_{2} - {x}_{1} ) ( {y}_{2} - {y}_{1} )} {Q}_{22} \qquad Formula 1$$

where:
   P is the indication value, determined with this formula for interpolating the lookup table;
   the Q values are the values in the lookup table with the corresponding x₁, x₂, y₁, and y₂ inputs;
   x and y are the vehicle speed and speed limit values respectively. x and y are input values, which lie between points in the lookup table x₁, and x₂ and y₁, and y₂ respectively. Once the value for P has been calculated, it is compared to a threshold to determine if the predetermined condition is met.

An example look-up table is provided below.

TABLE 1(a)
Example Look-Up Table

| | | | | | | Vehicle |
|---|---|---|---|---|---|---|
| | | | | | | speed x |
| | 80 | 120 | 160 | 200 | 233 | (km/h) |
| 233 | 100 | 100 | 100 | 100 | 100 | |
| 200 | 100 | 100 | 100 | 50 | 50 | |
| 160 | 100 | 100 | 33 | 33 | 33 | |
| Limit, y | | | | | | |
| (km/h) | | | | | | |

Consider a worked example, based on look-up table as shown in Table 1(a). Let the vehicle speed, x, be 130 km/h, and the restriction speed, y, be 170 km/h. For the x₁, and x₂ values, we consider where on the x axis that 130 km/h falls, which is between 120 km/h and 160 km. As such, x₁, is 120 and x₂ is 160. Repeating on the y axis, 170 km/h is between 160 and 200. As such, y₁, is 160 and y₂ is 200. Next, the Q values are read from the look-up table based on the x₁, x₂, y₁, y₂ values. Q is the table value corresponding to x₁, y₁, in the table, so 100. Q₁₂ is the table value corresponding to x₁, y₂ so again 100. Q₂₁ is the table value corresponding to x₂, y₁, so 33. Q₂₂ is the table value corresponding to x₂, y₂ so 100. Table 1(b) is an annotated version of the Example Look-Up Table shown in Table 1(a). In Table 1(b), the values of x₁, x₂, y₁, and y₂ are marked on their respective axes, and the Q values to be used are italicized and underlined.

TABLE 1(b)
Example Look-Up Table with Annotations

| | | | | | | Vehicle |
|---|---|---|---|---|---|---|
| | | x₁ | x₂ | | | speed, x |
| | 80 | 120 | 160 | 200 | 233 | (km/h) |
| 233 | 100 | 100 | 100 | 100 | 100 | |
| y₂ 200 | 100 | 100 | 100 | 50 | 50 | |
| y₁ 160 | 100 | 100 | 33 | 33 | 33 | |
| Limit, y | | | | | | |
| (km/h) | | | | | | |

Calculating P according to the formula, we get

$$\frac{( 160 - 130 ) ( 200 - 170 )}{( 160 - 120 ) ( 200 - 160 )} ( 100 ) + \frac{( 130 - 120 ) ( 200 - 170 )}{( 160 - 120 ) ( 200 - 160 )} ( 33 ) + \frac{( 160 - 130 ) ( 170 - 160 )}{( 160 - 120 ) ( 200 - 160 )} ( 100 ) + \frac{( 130 - 120 ) ( 170 - 160 )}{( 160 - 120 ) ( 200 - 160 )} ( 100 )$$

$$then$$

$$\frac{( 30 ) ( 30 )}{( 40 ) ( 40 )} ( 100 ) + \frac{( 10 ) ( 30 )}{( 40 ) ( 40 )} ( 33 ) + \frac{( 30 ) ( 10 )}{( 40 ) ( 40 )} ( 100 ) + \frac{( 10 ) ( 10 )}{( 40 ) ( 40 )} ( 1 \; 00 )$$

$$then$$

$$\frac{( 900 )}{( 1600 )} ( 100 ) + \frac{( 300 )}{( 1600 )} ( 33 ) + \frac{( 300 )}{( 1600 )} ( 100 ) + \frac{( 100 )}{( 1600 )} ( 1 \; 00 )$$

$$then$$

$$56.2 5 + 6.1875 + 18.75 + 6.25 = 87.4375$$

Thus, in this example, P, the indication value is 87.4375. The threshold value in this example is 100. If the indication value P is less than 100, the indication is displayed on the display 302. The P value may be considered to represent a percentage, such that the gauge marker 410 would be located 87.4375% of the way between the lower limit 404 and upper limit 406 on the gauge 402. The position of the gauge marker 410 may be representative of the percentage within the resolution of the gauge display but need not be exactly positioned to the percentage value. For example, for this P value, the gauge marker may be displayed at a position between 85% and 90% of the way between the lower limit 404 and upper limit 406 on the gauge 402. In another example, the gauge marker 410 may be positioned to align with a position representative of the nearest integer percentage value. As such, for this P value, the gauge marker 410 may be displayed at a position corresponding to at 87% on the gauge 402. The values of the look-up table may be chosen to allow the P value to be treated as a percentage in this way.

At any vehicle speed which is in between the threshold for display of the indication and the restriction speed, the indication value may be interpolated according to how close the vehicle speed is to the restriction speed, compared with the difference between the restriction speed and the threshold for displaying the indication. With this method, if the driver accelerates to the restriction speed then the gauge marker 410, whose position is determined by the indication value, will tend to converge with the power indicator 408 (which represents the delivered traction power) when the restriction speed is reached. This convergence allows the driver to easily anticipate reaching the restriction speed. In another example, if the restriction speed is ramping down while the vehicle 100 is cruising at a high speed, then the driver will know that the maximum cruise speed is still reducing below the instantaneous speed while the limitation indicator is still moving down the gauge 402.

The look-up table may be calibrated based on a power graph for the vehicle type and user-behaviour information. In this way, the threshold value may be related to the time it typically takes for the vehicle 100 to accelerate to the restriction speed from a lower speed, and may further be related to likely driver manoeuvres when starting at a lower speed. For example, if the restriction speed is as low as 100 km/h, then the indication could be visible when the vehicle 100 is stationary, because the driver may expect to reach more than 100 km/h within a short time of pulling away from rest (e.g. on a highway slipway). In another example, if the speed restriction is 160 km/h, then the indication need not appear until the vehicle 100 is travelling at more than 120 km/h, because it typically takes longer to accelerate from 100 km/h to 160 km/h than it does to accelerate from 0 km/h to 100 km/h, and the driver will not usually be anticipating driving at 160 km/h until they are already driving at a speed suitable only for highways. If the speed restriction is at a higher speed still, then the threshold for displaying the indication can be even closer to the restriction speed, because of the longer time it takes for the vehicle 100 to accelerate to higher speeds.

It will be understood that, while the display 302b of FIGS. 6(a), (b), and (c) include the gauge marker 410 as an indication of a speed restriction and the power indicator 408, the power indicator 408 is not relevant to alerting the driver to the existence of the speed restriction. The position of the gauge marker 410 on the power gauge 402 when the vehicle 100 is travelling at the restriction speed may be designed to be close to or equal to the position that represents the typical power required to maintain the vehicle 100 at that speed. In an example, the gauge marker 410 and power indicator 408 are located touching against each other. At any time when the vehicle speed is less than the restriction speed, the power indicator 408 can be anywhere up to the position of the gauge marker 410 while the vehicle is accelerating. Only at a steady speed (and nominal road load) will the power indicator 408 necessarily be less than the gauge marker 410 while traveling at less than the restriction speed.

As the power indicator 408 is closer to the lower limit in FIG. 6(b) than in 6(a), we can see that the vehicle is accelerating at slower rate in FIG. 6(b) than in FIG. 6(a). In this case, this will be because the driver is requesting less power in FIG. 6(b) than in FIG. 6(a). If the driver had kept the same acceleration demand from FIG. 6(a), then the gauge marker 410 would have converged with the power indicator 408 before the vehicle reached 116 km/h and thereafter the power indicator 408 would have come down matching the position of the gauge marker 410 until the vehicle speed and both indicators 408, 410 settled. It is useful to prevent the power indicator 408 from displaying a value greater than the gauge marker 410, even in the limited and typically transient cases where the power delivery is greater than the position indicated by gauge marker 410. In this way, the data output by the display 302b remains understandable to the driver.

When the vehicle 100 is travelling at the restriction speed, the gauge marker 410 may settle at a position on the gauge 402 that represents the nominal power needed to maintain that speed. The may aid understanding of the speed restriction by the driver. This may be achieved by appropriate choice of the values within the look-up table. In an example, these values may be chosen by firstly calculating or measuring the nominal power required to maintain the vehicle at a steady speed, as a function of vehicle speed. This may include considering the power requirements for a vehicle of a given weight and tyre pressure to overcome road load on a flat surface and so identify the torque for maintaining the speed in question. Other factors that may also be considered include the anticipated length/time of the journey or portion of journey, for example, a portion in a restricted speed zone, and other information that may be available from GPS or mapping data.

After determining the nominal power required to maintain the vehicle at a steady speed as a function of vehicle speed, this is expressed as a proportion of the nominal powertrain available power as a function of vehicle speed. As such, at any given speed, the proportion is the power required to maintain steady speed divided by the nominal powertrain available power. This proportion is then expressed as a percentage and used as an entry in the look-up table where the speed restriction matches the vehicle speed. For entries where the restriction speed is greater than the vehicle speed, larger values are entered into the lookup table. For example, in Table 1 above, where the restriction speed is higher than the vehicle speed, the entry in the look-up table is 100.

Table 2 below shows example percentage values derived according for a range of vehicle speeds.

TABLE 2

| Vehicle | | Nominal | Power to maintain |
|---|---|---|---|
| speed | Power to maintain | Powertrain | speed/Nominal |
| (km/h) | speed (kW) | Capability (kW) | capability (%) |
| 0 | 0 | 0 | N/A |
| 40 | 10 | 163 | 6% |
| 80 | 38 | 326 | 12% |
| 120 | 86 | 326 | 27% |
| 160 | 154 | 326 | 47% |
| 200 | 240 | 326 | 74% |
| 233 | 326 | 326 | 100% |

The percentage values from the final column of Table 2 can be inserted into Table 1 at the points where x and y are equal to each other and equal to the corresponding vehicle speed in Table 2.

The values in the look-up table may be generated and stored in memory accessible by the control system. The values may be recalculated or adjusted based on data received during a journey. Such data may be received from other systems or vehicles within the vehicle, or may be received from external systems. The control system 200 may receive relevant data for facilitating convergence of the gauge marker 410 and power indicator 408. The data may be received as part of the restriction data.

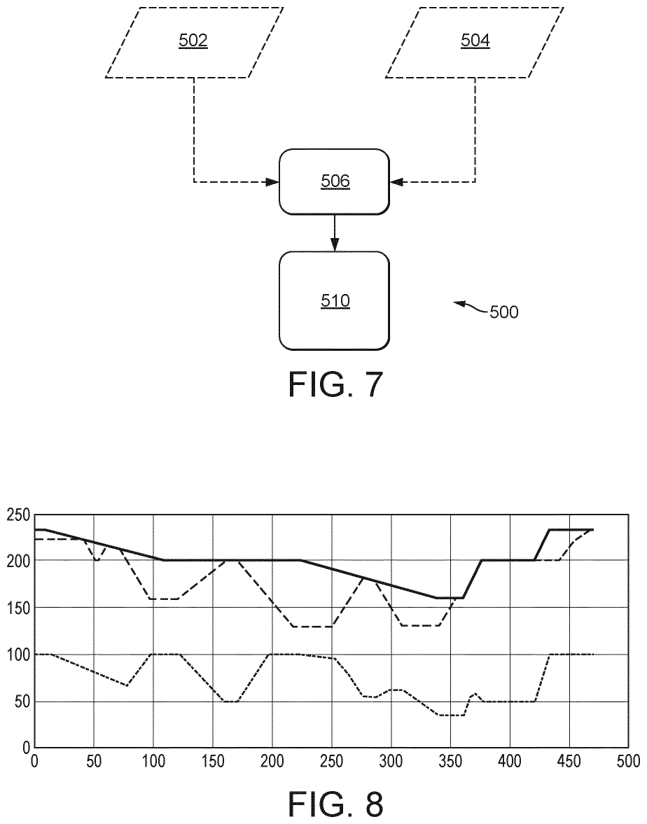

Referring now to FIG. 7, there is shown a flow chart of a method of rendering on a vehicle display system 300, indicated generally by the reference numeral 500, according to an embodiment of the invention. The method 500 may be implemented by the control system 200 described in relation to FIG. 2. The method may result in the display of an indication in the form of a gauge marker 410 as described in relation to FIGS. 4 and 6. Inputs of restriction data 502 and speed data 504 are received. The restriction data 502 relates to a speed restriction of the vehicle. The speed data 504 comprises the speed the vehicle is travelling. At block 506, the restriction data 502 and speed data 504 are assessed to determine if the predetermined criterion has been met. The method 500 continues to evaluate the restriction data 502 and speed data 504 in relation to the predetermined criterion. If, at block 506, the criterion is determined to have been met, the method 500 moves to block 510 and causes an indication to be displayed that the vehicle is subject to a speed restriction. If the criterion has not been met, and no indication is displayed, the method may continue to monitor the restriction data 502 and speed data 504.

The restriction data may include a restriction speed to which the vehicle is restricted. Determining whether the predetermined criterion is met may comprise calculating a value for a first function of the restriction speed and the speed the vehicle is travelling, and assessing that value in relation to a threshold value. Displaying the indication may comprise displaying the indication at a position determined by an indication value, wherein the indication value is a value for a second function of the restriction speed and the speed the vehicle is travelling. The first function and second function may be identical such that determining if the predetermined condition is met comprises assessing the indication value in relation to the threshold value.

The method may comprise the second function configured such that the indication value corresponds to a value representative of a power suitable for maintaining the restriction power as a portion of the power capability of the powertrain 102. The method may comprise deriving a value for one or both of the first and second function from a look-up table based on the speed of the vehicle 100. The look-up table may comprise values representative of a power suitable for maintaining the vehicle 100 at a steady speed as a portion of the power capability of the powertrain 102.

Determining whether the predetermined criterion is met may comprise determining whether the speed data indicates that the speed the vehicle is travelling is within a threshold value of the restriction speed. For example, the threshold value be between 25 km/h and 100 km/h. The threshold value may be a function of the restriction speed. For example, the threshold value may be a percentage of the restriction speed. Displaying the indication may comprise displaying the indication at a position determined by an indication value that is a function of the speed the vehicle is travelling and the speed limitation speed.

Referring now to FIG. 8, there is shown a graph illustrating the operation of an embodiment of the invention. The X axis represents time in seconds. The graph shows three tracks, including a first track illustrated with a solid line representing the “Restriction speed” a second track illustrated with a large-dashed line representing “Vehicle Speed (km/h)”; and a third track, illustrated in a small-dashed line representing “Indication Value”. For this example, the indication value is calculated according to Formula 1 above, where the indication is displayed when the indication value drops below a threshold value. In the graph, the maximum speed under normal operating conditions is assumed to be 233 km/h, and this is the value of the Vehicle Speed track at the start and the end of the graph, thus there is no applied speed restriction when the Restriction Speed track is at 233 km/h. When the Restriction Speed track deviates from this maximum value, it may ramp downward at 20 km/h, it may be at a steady speed and at other times, it may slew upward. The Vehicle Speed increases and decreases at different times. The values of the Vehicle Speed track and the Restriction Speed track are not intended to be real world example speeds, the values are chosen for illustrative purposes. The Indication Value track of the graph relates to the display of the indication. The graph illustrates an example where the indication value begins to drop below 100 when the Vehicle Speed track is within 40 km/h of the Restriction Speed track. At approximately 160 on the Time axis, the Indication Value track drops to a value of 50 for a Vehicle Speed limited to a Restriction Speed of 200 km/h, and later at approximately 350 on the Time axis to a value of 33 for a Vehicle Speed limited to a Restriction Speed of 160 km/h. The indication that the vehicle is subject to a speed restriction is displayed at times when the Indication Value track drops below a threshold value of 100. The indication values illustrated in the graph would cause the gauge marker 410 to begin to sweep in from the upper limit of the gauge 402 when the vehicle speed is within 40 km/h of the restriction speed, to a point half way (50%) between the lower limit 404 and upper limit 406 when the vehicle and restriction speeds are 200 km/h, and to a point one third (33%) of the distance along the gauge 402 from the lower limit 404 when the vehicle and restriction speeds are 160 km/h. It can be seen that when the Restriction Speed track is spaced apart from the Vehicle Speed track, the Indication Value track is at 100, illustrating the indication will not be shown on the display 302. This can be seen for example around the 100 mark on the Time axis, and around the 200 mark. However, at times when the Vehicle Speed track and the Restriction Speed track are close together, indicating that the vehicle speed is approaching the restriction speed, the Indication Value drops below the horizontal 100 gridline, illustrating that the indication will be displayed on the display at those times. In this example, the indication value at any time may be considered as the percentage distance along the gauge from the lower limit 404 the gauge marker 410 will be displayed, however, it is will be understood that this is not essential.

In all the embodiments described above, the predetermined thresholds include a certain degree of hysteresis to prevent flickering of the display when the conditions remain close to the threshold. For similar reasons, a de-bounce timer may be included.

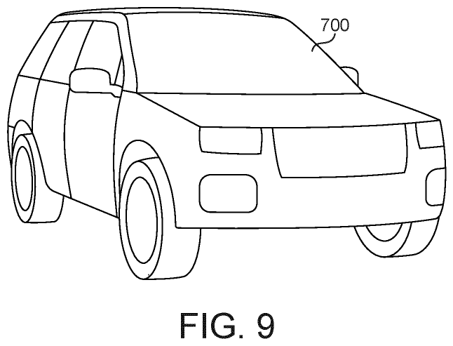

A vehicle 700 in accordance with an embodiment of the present invention is described herein with reference to the accompanying FIG. 9. The vehicle 700 may comprise a control system 200 as described herein. The vehicle may comprise a vehicle display system 300 as described herein. Certain aspects of the disclosure may be implemented using machine-readable instructions which may, for example, be executed by a general purpose computer, a special purpose computer, an embedded processor or processors of other programmable data processing devices to realize the functions described in the description and diagrams. In particular, a processor or processing apparatus may execute the machine-readable instructions. Thus, functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Certain operational conditions of the powertrain of the vehicle may require that a speed restriction is applied to the vehicle, such that it cannot go above that speed. The driver may not always need to know if a speed restriction has been imposed, for example, if the speed restriction is imposed at 160 km/h and the vehicle is currently driving at 50 km/h. The invention provides for alerting a driver to a speed restriction when it is relevant. The invention considers the restriction speed, the vehicle speed, and assesses if they meet a criterion for display of an indication that a speed restriction in place.

It will be appreciated that various changes and modifications can be made to the present invention without departing from the scope of the present application.

1. A control system for a vehicle display system for a vehicle, the control system comprising one or more controller, wherein the vehicle display system is configured to display information relating to the operation of a powertrain of the vehicle and the control system is arranged to:
receive restriction data, including a restriction speed to which the vehicle is restricted, relating to a powertrain-related speed restriction of the vehicle and speed data comprising a speed the vehicle is travelling;
determine from the restriction data and the speed data whether a predetermined criterion is met, said determination comprising calculating a value for a first function of the restriction speed and the speed the vehicle is travelling, and assessing that value in relation to a threshold value; and
output a signal to the vehicle display system to display an indication that the vehicle is subject to a speed restriction when the predetermined criterion is met, said indication comprising an indication value, wherein the indication value is a value for a second function of the restriction speed and the speed the vehicle is travelling; and
wherein the first function and second function are the identical such that the indication value is assessed in relation to the threshold value to determine if the predetermined condition is met.

2.-5. (canceled)

6. A control system according to claim 1 wherein the second function is configured such that the indication value corresponds to a value representative of a power suitable for maintaining the restriction speed as a proportion of a power capability of the powertrain.

7. A control system according to claim 1 wherein a value for one or both of the first function and the second function is derived from a look-up table based on the speed the vehicle is travelling and the restriction speed.

8. A control system as claimed in claim 7 wherein the look-up table comprises values representative of a power suitable for maintaining the vehicle at a steady speed as a proportion of a power capability of the powertrain.

9. A vehicle display system for a vehicle, the vehicle display system configured to display information relating to the operation of a powertrain of the vehicle and comprising the control system according to claim 1.

10. A vehicle display system as claimed in claim 9, wherein the display comprises a gauge having a lower limit representing zero or negligible power delivery of the powertrain and an upper limit representing maximum power delivery equal to the instantaneous power capability, and the gauge marker is positionable between the lower limit and the upper limit.

11. A vehicle display system as claimed in claim 10, where the gauge marker is positionable on the gauge at a position corresponding to the indication value.

12. A method of rendering, on a vehicle display system, information relating to the operation of a powertrain of the vehicle, the method comprising: determining from restriction data, including a restriction speed to which the vehicle is restricted, relating to a speed restriction of the vehicle and speed data comprising a speed the vehicle is travelling whether a predetermined criterion is met, said determination comprising calculating a value for a first function of the restriction speed and the speed the vehicle is travelling, and assessing that value in relation to a threshold value; and displaying an indication, at a position determined by an indication value, that the vehicle is subject to a speed restriction when the predetermined criterion is met, wherein the indication value is a value for a second function of the restriction speed and the speed the vehicle is travelling; and
wherein the first function and second function are identical such that determining if the predetermined condition is met comprises assessing the indication value in relation to the threshold value.

13. A non-transitory computer-readable data carrier having stored thereon a computer program comprising instructions which, when the program is executed by a computer, cause the computer to carry out the method of claim 12.

14. A vehicle comprising the control system according to claim 1.

15. A vehicle comprising the vehicle display system according to claim 9.

16. A vehicle display system as claimed in claim 9, further comprising a display to graphically render information relating to the operation of the powertrain of the vehicle and wherein the output is configured to include a signal for a gauge marker on the display as the indication.

17. A vehicle display system as claimed in claim 11, wherein the display comprises a power indicator adapted to represent the instantaneous power delivery of the powertrain as a proportion of the instantaneous power capability wherein the power indicator is positionable between the lower limit of the gauge and the gauge marker.
